(19) United States
(12) Patent Application Publication
(10) Pub. No.: US 2017/0098392 A1
(43) Pub. Date: Apr. 6, 2017

(54) CURRENT LOCATION INDICATION MEDIUM AND CURRENT LOCATION INDICATION MEDIUM CREATING APPARATUS

(71) Applicant: Seiko Epson Corporation, Tokyo (JP)

(72) Inventors: Shigeyoshi MIYAZAWA, Matsumoto (JP); Hiroaki HOSOMI, Minowa (JP)

(21) Appl. No.: 14/874,765

(22) Filed: Oct. 5, 2015

(51) Int. Cl. G09F 3/02; G09F 3/00; G09F 3/10

(52) U.S. Cl. CPC G09F 3/02; G09F 3/10; G09F 3/0297; G09F 2003/0208; G09F 2003/0213

(57) ABSTRACT

Disclosed is a current location indication medium including descriptions of: at least one of current address information or landmark information, which is recorded on the current location indication medium, of an installation location; and grid map information, which is recorded on the current location indication medium, defined by an international standard.

### BACKGROUND

1. Technical Field

The present invention relates to a current location indication medium and a current location indication medium creating apparatus capable of indicating a current location where the current location indication medium is installed.

2. Related Art

In the related art, for example, as an indication which indicates a current location, an address indication board or the like installed on utility poles or walls of house has been used.

As an example of such an address indication board, there is an address indication board on which a direction is also described in addition to an address (for example, see JP-A-2003-157008).

In the event of a disaster such as tsunami or earthquakes, there is a case where relief activities are carried out by a fire brigade or the armed forces who come to the site from a distance including foreign countries. However, in the related art, since an indication in a current location indication column is configured of information such as an address or a postal code, there is a problem in that those who come to the site from a distance including foreign countries can not accurately recognize a local location.

### SUMMARY

An advantage of some aspects of the invention is to provide a current location indication medium and a current location indication medium creating apparatus that accurately notifies a current location to even those who come to the site from a distance including foreign countries.

According to an aspect of the invention, there is provided a current location indication medium including descriptions of at least one of current address information and landmark information of an installation location where the current location indication medium is installed, and grid map information defined by an international standard.

In this case, it is possible to accurately notify a current location in an unknown land.

In the current location indication medium, the grid map information may be configured of an area code and location coordinate information, and a size of a font of the location coordinate information may be larger than that of a font of the area code.

In this case, it is possible to easily recognize location coordination information that is the most important information when indicating a current location indication.

The current location indication medium may further include a description of a two-dimensional code, in which at least the grid map information is recorded.

In this case, it is possible to accurately notify the third person of a current location with a two-dimensional code read by a mobile terminal device or the like.

In the current location indication medium, different colors may be applied to different areas in at least a portion according to the location coordinate information based on the grid map information.

In this case, by applying colors for town names and districts of the location at which the current location indication medium is installed, it is possible to effectively classify the current location indication medium at each area and improve the efficiency of installation work, when installing the current location indication medium.

In the current location indication medium, the location coordinate information may be indicated as at least one of 4 digits-4 digits, 4 digits-5 digits, 5 digits-4 digits, and 5 digits-5 digits according to an installation location.

In this case, it is possible to perform indication of a current location based on an installation location by selecting the number of the digits of the location coordinate information according to an installation location of the current location indication medium.

In the current location indication medium, height information of the installation location may be further recorded on the current location indication medium.

In this case, it is possible to specify an accurate location of an installation location by recording height information of an installation location on the current location indication medium.

The current location indication medium may include an indication surface and a paste surface that is provided in a rear side of the indication surface, and the paste surface may be configured to exhibit an adhesion.

In this case, it is possible to easily install at an installation location by adhesion of a paste surface of the current location indication medium.

According to another aspect of the invention, there is provided a current location indication medium creating apparatus including descriptions of: a printing unit that prints a current location indication medium, the current location indication medium including, on the basis of location information of a current location, at least one of current address information and landmark information of an installation location, and grid map information defined by an international standard.

In this case, it is possible to create a current location indication medium capable of accurately notifying a current location in an unknown land.

In the current location indication medium creating apparatus, the current location indication medium may include an indication surface and a paste surface that is provided in a rear side of the indication surface, and the paste surface may be configured to exhibit an adhesion.

In this case, it is possible to create the current location indication medium which is able to easily install the current location indication medium at an installation location by adhesion of a paste surface of a current location indication medium.

In the current location indication medium creating apparatus, the current location indication medium may be configured of a tape cartridge in which a tape and an ink ribbon are integrated, and may be obtained by performing printing on the tape of the tape cartridge through the ink ribbon.

In this case, it is possible to create a current location indication medium without supplying a paper or an ink by using a tape cartridge.

In the current location indication medium creating apparatus, the current location indication medium may be configured of droplets and the current location indication medium may be fixed by ejecting the droplets in an installation location.

In this case, a sheet such as a film or a paper may be not required by fixing the current location indication medium, in an installation location, by directly ejecting ink in the installation location.

The current location indication medium creating apparatus may further include a built-in battery that drives the current location indication medium creating apparatus.

In this case, it is possible to use the current location indication medium creating apparatus in a location in which there is not a power source.

### BRIEF DESCRIPTION OF THE DRAWINGS

The invention will be described with reference to the accompanying drawings, wherein like numbers reference like elements.

FIG. 1 is a front view illustrating a current location indication medium according to an embodiment of the invention.

FIGS. 2A to 2E are diagrams illustrating installation examples of the current location indication medium according to the embodiment.

FIG. 3 is a schematic perspective view illustrating a current location indication medium creating apparatus according to an embodiment of the invention.

FIG. 4 is a block diagram illustrating a control configuration of the embodiment.

### DESCRIPTION OF EXEMPLARY EMBODIMENTS

Hereinafter, an embodiment according to the invention will be described with reference to the drawings.

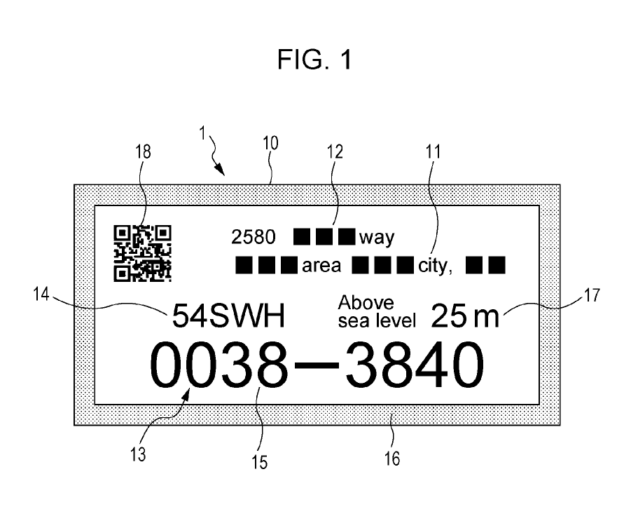

FIG. 1 is a front view illustrating a current location indication medium according to the embodiment.

As described in FIG. 1, the current location indication medium 1, for example, is formed of a rectangular sheet-shaped medium 10, such as a film or a paper like a plastic film or a synthetic paper. Since the current location indication medium 1 is mostly installed outdoors, it is preferable that the current location indication medium 1 is formed of the medium 10 having weather resistance.

At least one of current address information 11 and landmark information 12 is described on a surface of the current location indication medium 1, and further grid map information 13 which is defined by an international standard in an installation location is also described on a surface of the current location indication medium 1.

It is preferable that at least one of the current address information 11 and the landmark information 12 and the grid map information 13 which is defined by an international standard are recorded together on the single current location indication medium 1. However, these pieces of information may be separately recorded on a plurality of the current location indication media 1. In this case, the plurality of the current location indication media 1 are configured as a set.

For example, UTM grid information or military grid reference system (MGRS) information is used as the grid map information 13. The UTM grid information or the MGRS information is configured from a predetermined area code 14 and location coordinate information 15. It is possible to specify a location on the earth by the area code 14 and the location coordinate information 15.

In this embodiment, the area code 14 illustrated as “54SWH” and the location coordinate information 15 illustrated as “0038-3840” in FIG. 1 are described as the grid map information 13.

Here, the “54” of the area code 14 indicates a longitude zone name, for example, east longitude of 132-138 degrees is indicated as 53 and east longitude of 138-144 degrees is indicated as 54.

The “S” of the area code 14 corresponds to an alphabet character which is assigned by dividing a latitudinal direction (north-south direction) to every 8 degrees. For example, north latitude of 24-32 degrees is indicated as R and 32-40 degrees is indicated as S.

The “WH” of the area code 14 indicates a 100 km square area by two alphabet characters using a constant notation.

In addition, the first 4-digit number “0038” of the location coordinate information 15 indicates a UTM coordinate value in a longitude direction (east-west direction). The last 4-digit number “3840” of the location coordinate information 15 indicates a UTM coordinate value in a latitude direction (north-south direction).

When the location coordinate information 15 is 4 digits, it is possible to specify a 10 m square area. When the location coordinate information 15 is 3 digits, it is possible to specify a 100 m square area. In a case of 5 digits, it is possible to specify a 1 m square area.

For this reason, for example, when the current location indication medium 1 is installed at areas such as cities where buildings are dense, the location coordinate information 15 is preferably indicated as 5 digits because it is practical to perform more detail current location indication. In addition, when the current location indication medium 1 is installed at areas where there are no many buildings, the location coordinate information 15 may be indicated as 3 digits because it is considered to be sufficient for current location indication in a wider range.

When the current location is recorded by the longitude and latitude, for example, in a case of 5 digits, an integer part requires 3 digits, and thus the decimal point becomes 2 digits. Since one degree of the longitude and latitude is approximately 111 km (40000 km/360 degrees), digits of the decimal point represent an accuracy of approximately 1.11 km. An accuracy of approximately 11 m is obtained by using 4 digits of the decimal point (that is, a total of 7 digits).

Therefore, 7 digits-7 digits or more character strings are requested for the designation of location in the longitude and latitude, and when people communicate with each other in verbal, there is a possibility of occurrence of miscommunication.

In this reason, the use of the grid coordinates is highly effective. Particularly, in the UTM coordinate values, the accuracy of the longitude and latitude in a combination of the case of the 4 digits-4 digits becomes the same as that of the 7 digits-7 digits.

According to the embodiment, the location coordinate information 15 is indicated as at least one combination of 4 digits-4 digits, 4 digits-5 digits, 5 digits-4 digits, and 5 digits-5 digits according to an installation location.

In addition, in the current location indication medium 1 of the embodiment, the displayed area size of the location coordinate information 15 is described larger than the displayed area size of the area code 14. That is, the most important information is the location coordinate information 15 in a case where a current location is indicated. And thus, it is possible to easily recognize a current location by describing a font size of the current coordinate information 15 larger than that of the area code 14.

Furthermore, at least one of the current location information 11 and the landmark information 12 of an installation location is described on the current location indication medium 1. In a case in FIG. 1, an example is illustrated in which both the current address information 11 and information of “2580 ▪ ▪ ▪way” which is the landmark information 12 of the installation location are described.

The landmark information 12, for example, includes information of buildings or facilities to be marked such as a ◯◯ elementary school, a ◯◯ park, a ◯◯ supermarket, and the like in the area. At least one of the current location information 11 and the landmark information 12 may be described on the current location indication medium 1.

In addition, in the present embodiment, as described in hatching in FIG. 1, a colored area 16 indicated as different colors for different areas according to the location coordinate information 15 based on the grid map information 13 is formed as an edge of the current location indication medium 1. That is, for example, by coloring for each location of town names or districts at which the current location indication medium 1 is installed, it is possible to effectively classify the current location indication medium 1 for each area and improve the efficiency of installation work, when installing the current location indication medium 1.

In addition, the colored area 16 is not limited to the edge of the current location indication medium 1. For example, it is possible to arbitrarily set the colored area as a central portion, the entire surface, or the like of the current location indication medium 1 if necessary. Rather than the coloring, it is also possible to change a design or the like of the current location indication medium 1 at each installation area.

Furthermore, height information of the installation location is described on the current location indication medium 1. According to this embodiment, as the height information of the installation location, sea level information 17 such as “above sea level 25 m” is described.

The grid map information 13 has a function that specifies a plane location on the earth, but does not include information that specifies a height. For this reason, it is possible to specify an accurate location of an installation location by describing the sea level information 17 that is the height information of the installation location of the current location indication medium 1.

In addition to the height information, it is preferable to describe distance information from the coast, evacuation site information, guidance information to the evacuation site or the like in the event of a disaster, for example, as information for evacuating from the tsunami or the like.

A two-dimensional code 18 such as a QR code (registered trademark), or the like, for example, is described on the current location indication medium 1. Information to be written to the two-dimensional code 18 includes at least the grid map information 13.

That is, when the grid map information 13 is notified to a third person by viewing the current location indication medium 1, if the number of digits of the grid map information 13 is a lot, there is a possibility in that the information is incorrectly notified. In such a case, a mobile terminal device such as a smart phone reads the two-dimensional code 18, for example, and the grid map information 13 written to the two-dimensional code 18 is obtained. Accordingly, it is possible to accurately notify the grid map information 13, for example, when the obtained information is automatically notified to a disaster prevention center or the like.

As another piece of information to be written to the two-dimensional code 18, for example, it is considered that information relating to an evacuation direction from the current location, the sea level information, or the like.

As described above, for example, it is preferable to record an automatic notification application for performing automatic notification to the disaster prevention center in the two-dimensional code 18. In this case, it is preferable to notify the current location based on the grid map information 13 for the disaster prevention center to transmit the most effective evacuation route from the current location to the mobile terminal device in a case where the mobile terminal device reads the two-dimensional code 18.

A rear surface of the current location indication medium 1 is a paste surface. The paste surface is configured to exhibit adhesion. For example, the paste surface of the current location indication medium 1 is coated with an adhesive, and a mount sheet is attached on a rear surface of the adhesive.

Therefore, it is possible to install the current location indication medium 1 by detaching the mount sheet from the adhesive and attaching the paste surface to a predetermined installation location using the adhesive.

In addition, for example, it is preferable to exhibit adhesion by heating the adhesive when installing the current location indication medium 1 by coating the paste surface with an adhesive exhibiting stickiness through heating.

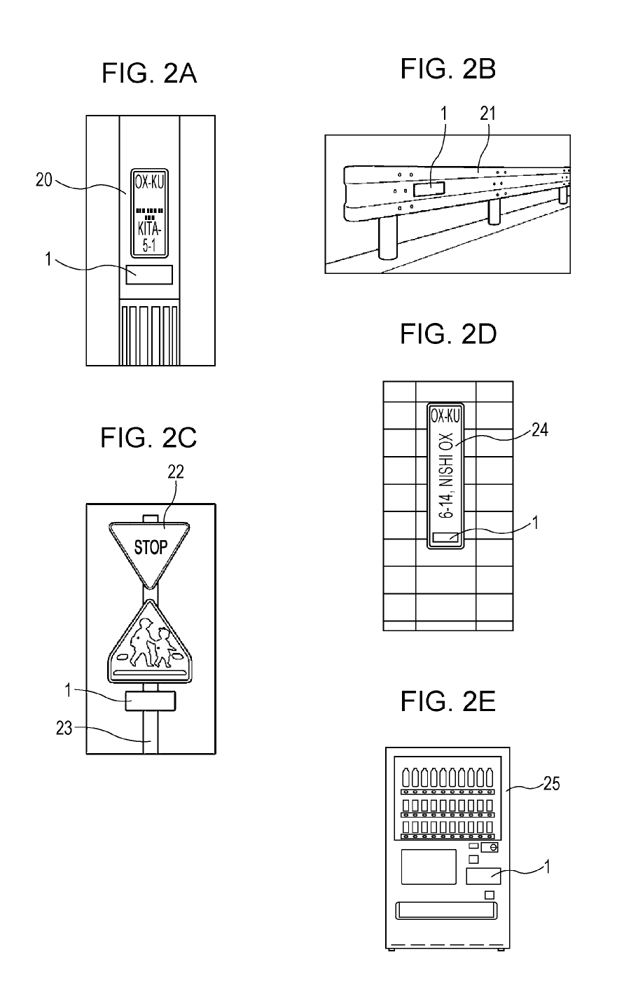

Next, examples of installation locations of the current location indication medium 1 will be described with reference to FIG. 2A to 2E.

FIGS. 2A to 2E are explanatory views illustrating examples of installation locations of the current location indication medium 1.

For example, as described in FIG. 2A, the current location indication medium 1 may be installed on utility poles 20. As described in FIG. 2B, the current location indication medium 1 may be installed on guardrails 21 of road sides.

In addition, as described in FIG. 2C, the current location indication medium 1 may be installed on road signs 22. In this case, for example, the current location indication medium 1 may be implemented to be held by a plate such as a plastic, a metal, or the like so as to be installed on struts 23 for being installed on the road sign 22.

Furthermore, as illustrated in FIG. 2D, it is preferable to install the current location indication medium 1 on an address indication plate 24. As illustrated in FIG. 2E, it is preferable to install the current location indication medium 1 on a vending machine 25.

In addition, the installation location of the current location indication medium 1 is not limited to these examples and may be installed at any location.

Hereinafter, an embodiment of a current location indication medium creating apparatus according to the invention will be described.

In this embodiment, an example of a printing apparatus used as the current location indication medium creating apparatus will be described.

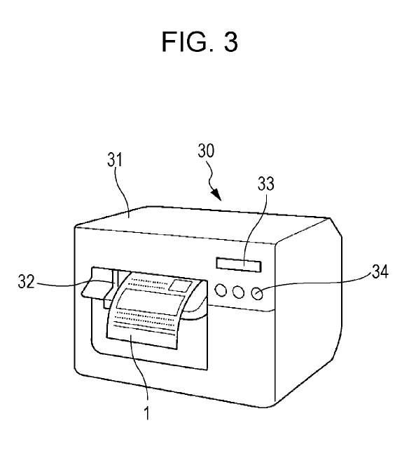

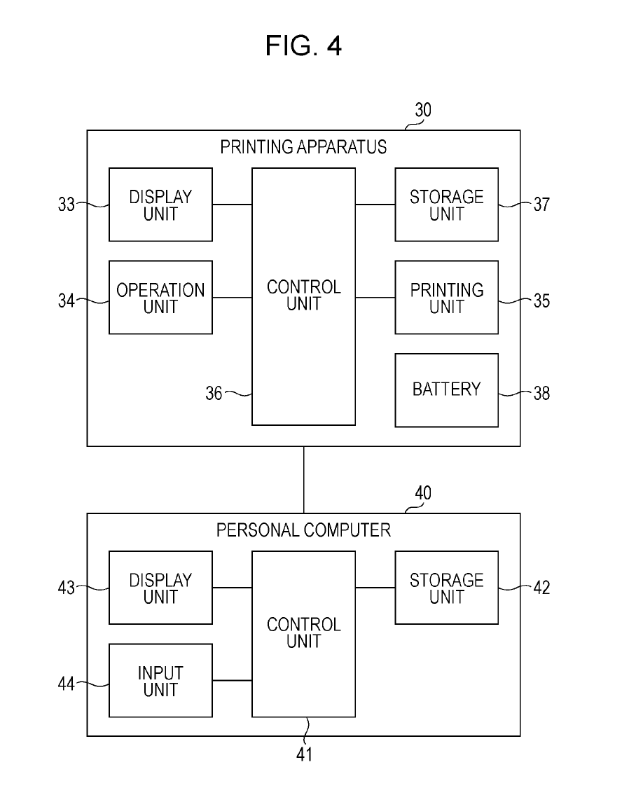

FIG. 3 is a perspective view illustrating an appearance of the printing apparatus. FIG. 4 is a block diagram illustrating a control configuration of the printing apparatus.

As described in FIG. 3, a printing apparatus 30 includes a printer body 31 with a rectangular shape. A paper outlet 32 that discharges the current location indication medium 1 after printing is provided to a front surface of the printer body 31. For example, a display unit 33, such as a liquid crystal display panel, which displays an image of a printing object or a menu screen and displays a predetermined display is provided to the front surface of the printer body 31.

An operation unit 34 is provided in a lower portion of the display unit 33 in the front surface of the printer body 31. The operation unit 34 includes a power source switch that switches a power source of the printing apparatus 30 and a selection switch that selects a desired selection item on the menu screen displayed on the display unit 33.

A printing unit 35 (see FIG. 4) capable of printing using an ink jet method, for example, is embedded in the printing apparatus 30 according to the embodiment. The printing apparatus 30 is a label printer that performs printing using the ink jet method on the current location indication medium 1 which is attached to a mount sheet through an adhesive.

In addition, as described in FIG. 4, the printing apparatus 30 includes a control unit 36, a storage unit 37, the printing unit 35, the display unit 33, an operation unit 34, and a battery 38. The printing apparatus 30 is coupled to a personal computer 40.

The control unit 36 controls printing operations by the printing unit 35 and centrally controls each unit of the printing apparatus 30. The storage unit 37 stores programs, various data, or the like to be executed by the control unit 36.

The printing unit 35 performs printing on a sheet according to a control signal from the control unit 36.

The display unit 33 displays an operation state of the printing apparatus 30, presence or absence of occurrence of an error, or another piece of information under the control of the control unit 36.

In the operation unit 34, a printing setting screen is opened from the menu screen, and various printing conditions may be set which are a type of printing medium, a size of the printing medium, printing quality, and the like, when a user operates the operation unit 34 while checking the display of the display unit 33.

The battery 38 supplies a power source to the control unit 36, the storage unit 37, the printing unit 35, the display unit 33, and the operation unit 34 of the printing apparatus 30. The printing apparatus 30 is able to be driven by the battery 38 at a location where there is no power source.

The personal computer 40 includes a control unit 41, a storage unit 42, a display unit 43, and an input unit 44. The control unit 41 controls centrally each unit. The storage unit 42 stores programs, various data, or the like to be executed by the control unit 41.

The display unit 43, for example, is a liquid crystal display panel and performs displays according to an input operation which is input from the input unit 44 under the control of the control unit 41. The input unit 44 is, for example, a key board or a mouse and transmits signals according to an input operation by a user to the control unit 41.

Next, operations of the printing apparatus 30 will be described.

In the embodiment, first, the personal computer 40 is connected to the printing apparatus 30 when the printing apparatus 30 is used. A user inputs the grid map information 13, the current address information 11 or the landmark information 12, sea level information 17, or the like using the input unit 44 of the personal computer 40. In addition, the two-dimensional code 18 is created according to the grid map information 13.

The control unit 41 creates a printing image in which the grid map information 13, the current address information 11 or the landmark information 12, and the sea level information 17 and the two-dimensional code 18 are disposed at predetermined areas.

Furthermore, the creation of these printing images is easy when respective information and the two-dimensional code 18 are created by using an application for automatically disposing the respective information and the two-dimensional code 18 at a predetermined location.

Subsequently, the printing apparatus 30 starts when a power source is input by a user manipulates the operation unit 34 to input a power. In this state, the control unit 36 controls the printing unit 35 and then performs printing on an desired current location indication medium 1 by the user instructing the printing of the printing image which is created in the personal computer 40.

The current location indication medium 1 in which the printing is completed is installed at an installation location by adhering the medium with an adhesive exposed after detaching a mount sheet.

As described above, in the embodiment, since at least one of the current address information 11 or the landmark information 12 of an installation location and the grid map information 13 are recorded on the current location indication medium 1, it is possible to accurately notify the current location in an unknown land. As a result, for example, the current location is accurately recognized even by firefighters, military personnel, or the like who visit from outside to rescue when a major disaster occurs.

Since location coordinate information 15 is described by using a font larger than that of the area code 14, it is possible to easily recognize the location coordinate information 15 which is the most important information when indicating a current location.

Furthermore, since the two-dimensional code 18 is described in which at least the grid map information 13 is recorded, it is possible to accurately notify the third person of a current location by allowing the mobile terminal device or the like to read the two-dimensional code 18.

In addition, since different colors are applied to different areas according to the location coordinate information 15 based on the grid map information 13, the current location indication medium 1 can be effectively classified for each area and the effectiveness of installation work improved when installing the current location indication medium 1.

Since the location coordinate information 15 is selectively indicated as 4 digits or 5 digits according to an installation location, it is possible to perform indication of a current location according to the installation location by selecting the number of the digits of the location coordinate information 15 based on an installation location of the current location indication medium 1.

In addition, since height information of an installation location is described, it is possible to specify an accurate location of an installation location by describing the height information of an installation location on the current location indication medium 1.

Since the current location indication medium includes an indication surface and a paste surface which is provided in the rear side of the indication surface and the paste surface is configured to exhibit adhesion, it is possible to easily install the current location indication medium 1 at an installation location by the adhesion of the paste surface of the current location indication medium 1.

The present invention is not limited to the above embodiment and can perform modifications within a range without departing from the gist of the invention.

For example, in the above embodiment, as the current location indication medium creating apparatus, a case of the printing apparatus 30 of an ink jet method is described, but it is not limited thereto. For example, it is possible to apply the printing apparatus 30 that prints a current location indication medium through an ink ribbon of a tape as a current location indication medium creating apparatus, by using a tape cartridge in which the tape and the ink ribbon are integrated as the current location indication medium.

In addition, in the above embodiment, the current location indication medium is described which is configured by printing the grid map information 13 or the like on a sheet such as a film or a paper as the current location indication medium 1, but it is not limited thereto. For example, the current location indication medium 1 may be fixed in an installation location, by directly ejecting droplets of ink from the current location indication medium creating apparatus at the installation location capable of performing by ejecting the droplets of ink to a distant area. As such a configuration, the current location indication medium 1 is formed from the droplet of ink. Therefore, in the current location indication medium 1, a sheet such as a film or a paper is not required.

What is claimed is:

1. A current location indication medium comprising descriptions of:
at least one of current address information and landmark information of an installation location; and
grid map information defined by an international standard.

2. The current location indication medium according to claim 1,
wherein the grid map information is configured of an area code and location coordinate information, and
a size of a font of the location coordinate information is larger than that of a font of the area code.

3. The current location indication medium according to claim 1, further comprising a description of:
a two-dimensional code, in which at least the grid map information is recorded.

4. The current location indication medium according to claim 1,
wherein different colors are applied to different areas in at least a portion according to the location coordinate information based on the grid map information.

5. The current location indication medium according to claim 1,
wherein the location coordinate information is indicated as at least one of 4 digits-4 digits, 4 digits-5 digits, 5 digits-4 digits, and 5 digits-5 digits according to the installation location.

6. The current location indication medium according to claim 1,
wherein height information in the installation location is further recorded on the current location indication medium.

7. The current location indication medium according to claim 1,
wherein the current location indication medium includes an indication surface and a paste surface that is provided in a rear side of the indication surface, and the paste surface is configured to exhibit an adhesion.

8. A current location indication medium creating apparatus comprising:
a printing unit that prints a current location indication medium, the current location indication medium including descriptions of on the basis of location information of a current location, at least one of current address information and landmark information of an installation location, and grid map information defined by an international standard.

9. The current location indication medium creating apparatus according to claim 8,
wherein the current location indication medium includes an indication surface and a paste surface that is provided in a rear side of the indication surface, and the paste surface is configured to exhibit an adhesion.

10. The current location indication medium creating apparatus according to claim 8,
wherein the current location indication medium is configured of a tape cartridge in which a tape and an ink ribbon are integrated, and is obtained by performing printing on the tape of the tape cartridge through the ink ribbon.

11. The current location indication medium creating apparatus according to claim 8,
wherein the current location indication medium is configured of droplets and the current location indication medium is fixed by ejecting the droplets at the installation location.

12. The current location indication medium creating apparatus according to claim 8, further comprising:
a built-in battery that drives the current location indication medium creating apparatus.
